(19) United States
(12) Patent Application Publication
(10) Pub. No.: US 2013/0227061 A1
(43) Pub. Date: Aug. 29, 2013

(54) ENGINE, SYSTEM AND METHOD OF PROVIDING LOCATION-BASED SOCIAL SERVICES

(71) Applicant: Bing Liu, Rolling Hills, CA (US)

(72) Inventor: Bing Liu, Rolling Hills, CA (US)

(21) Appl. No.: 13/768,719

(22) Filed: Feb. 15, 2013

Related U.S. Application Data
(63) Continuation-in-part of application No. 13/673,158, filed on Nov. 9, 2012.
(60) Provisional application No. 61/599,135, filed on Feb. 15, 2012.

(51) Int. Cl. H04L 29/08

(52) U.S. Cl. CPC H04L 67/18
USPC 709/217

(57) ABSTRACT

An engine, system and method for a domain social network that interconnects Internet users with at least domains owned by or of interest to those Internet users, and that may obtain and/or forward obtained dynamic data regarding those domains automatically, such as by web service or email service. The dynamic data may be used to filter and protect content and data of the respective domains, to protect users by identifying low quality web pages or malicious software or pages, to isolate or improve search results regarding the domain, and/or to improve Internet-based transaction flow, such as the creation of advertising.

### CROSS-REFERENCE TO RELATED APPLICATION

This application claims priority to U.S. Provisional Patent Application Ser. No. 61/599,135, filed Feb. 15, 2012, entitled Engine, System and Method of Providing Location-Based Social Services, and is a continuation-in-part of U.S. patent application Ser. No. 13/673,158, the entireties of which are expressly incorporated herein by reference in their entirety.

### FIELD OF THE INVENTION

The present invention relates to time-limited social interactions held in defined locations, and, more particularly, to an engine, system and method of providing a location-based social services.

### BACKGROUND OF THE INVENTION

The term “Web 2.0” is commonly associated with web applications that facilitate interactive information sharing, interoperability, user-centered design, and collaboration on the World Wide Web (WWW, also referred to hereinafter as the Internet or a network, further includes intranet, extranet, and the like). Web 2.0 thus necessarily includes aspects of connecting non-virtual identity to virtual identity on the WWW using a data feed comprised of data relationships and business and data intelligence. As used hereinthroughout, and unless otherwise noted, the term “identity” is defined to include non-virtual and/or virtual aspects of a person interacting on, with, or with others on, the WWW.

In an example of a typical social network, Facebook® connects an identity with other persons based on, for example, friendship. Further, persons using a social network platform such as the Facebook platform may generate activities, events, and the like, as indicated from the respective Facebook account associated with each respective identity. Once generated, the Facebook platform may automatically feed friends' activities, events, and the like to third person friends of the identity, such as when such activities or events are occurring or have occurred.

However, Facebook connects persons to persons, or persons/entities (such as businesses) to person/entities. Facebook does not provide any interconnection for domains associated with those persons or entities. Thus, in typical social environments such as Facebook, persons/entities generate and receive the data. That is, the Facebook platform feeds data to and from the friends identified as being associated with each identity. Needless to say, data generated in this way, and absent data monitoring regarding domain names associated with the persons/entities on Facebook, severely limits the usefulness of the data generated by such typical social sites—particularly for advertising purposes, for example.

Further, there are over 200 million domains as of 2010, and over 1.8 billion web users. These users are running approximately 15 billion web searches a year, which leads each user to 2-3 unknown websites per day, on average. Such websites, if unknown to the user and without any way for the user to have a trusted party (such as a social network friend, or a trusted domain) that indicates the acceptability of the unknown site, may pose a risk to users, such as an increased likelihood of phishing or providing malware.

Thus, there is a need for a “domain social network” that interconnects data regarding identities (i.e., persons/entities) to data regarding domains. More particularly, there is a need for an engine, system and method to generate domain data using, and that itself provides business intelligence logic, wherein data is related, such as for sales, advertising or trustworthiness, purposes, to an identity's activity.

### SUMMARY

The present invention provides an engine, system and method for a domain social network that interconnects Internet users with locations at the request of at least one user or by affiliation with the location(s) created within the present invention. The locations may be physical and/or virtual in nature and may be used to facilitate communication between users, including the geographical location of both the location and the users whom have access to the location.

It is to be understood that both the foregoing general description and the following detailed description are exemplary and explanatory, and are intended to provide further explanation of the invention as discussed hereinthroughout.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods;

FIG. 2 is a block diagram showing an exemplary networked computing environment for use in accordance with herein described systems and methods;

FIG. 3 is an illustration of aspects of the present invention;

FIG. 4 is an illustration of a process flow of the present invention; and

FIG. 5 is an illustration of a system flow of the present invention.

### DETAILED DESCRIPTION

A computer-implemented platform and methods of use are disclosed that provide networked access to a plurality of types of digital content, including but not limited to video, audio, and document content, and that track and deliver the accessed content. Described embodiments are intended to be exemplary and not limiting. As such, it is contemplated that the herein described systems and methods can be adapted to provide many types of users with access and delivery of many types of domain data, and can be extended to provide enhancements and/or additions to the exemplary services described. The invention is intended to include all such extensions. Reference will now be made in detail to various exemplary and illustrative embodiments of the present invention.

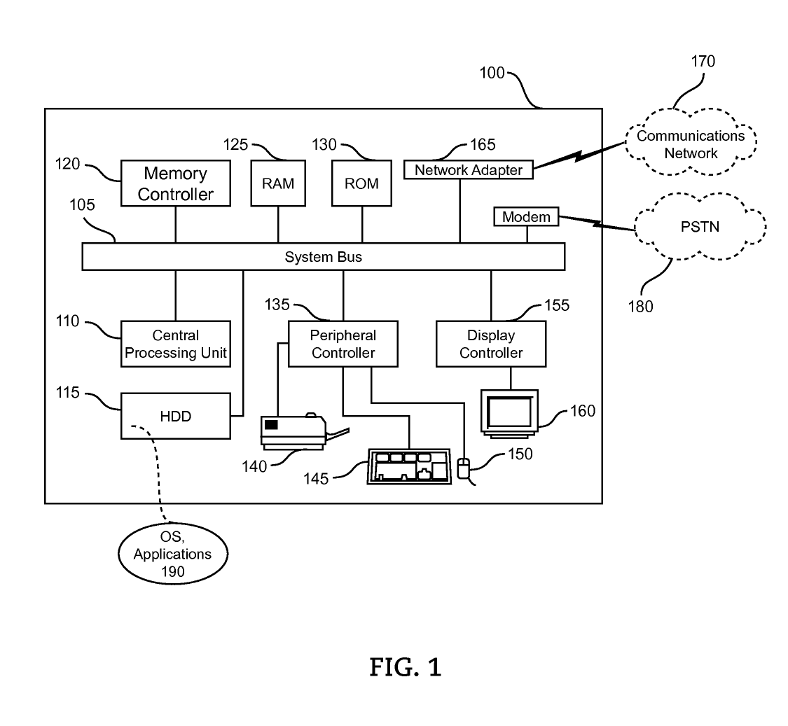

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

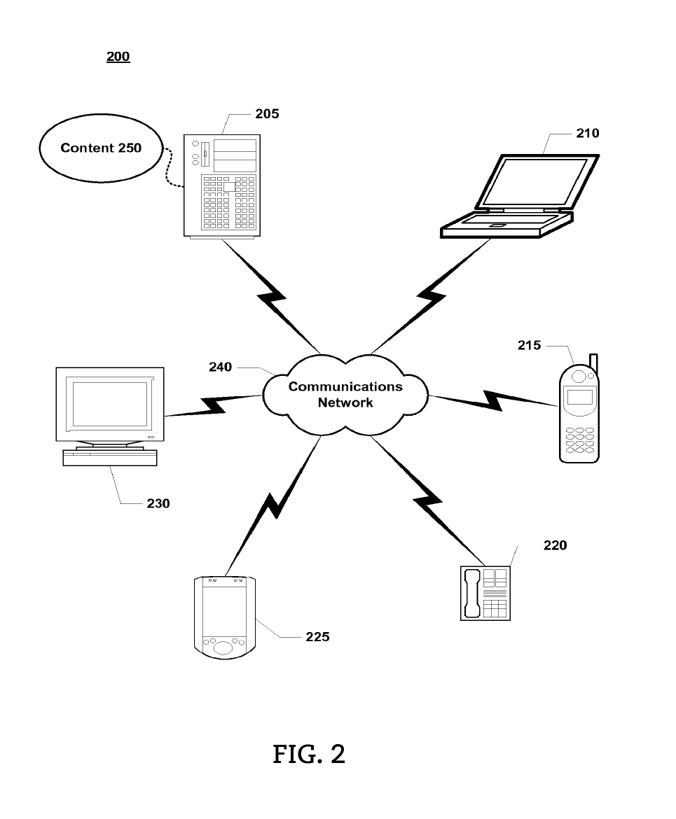

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

The present invention provides an engine, system and method for a domain social network that interconnects Internet users with at least domains owned or interested by those Internet users, and that may obtain and/or forward the dynamic data automatically, such as by web service or email service. The dynamic data may be used to filter and protect content and data of the respective domains, to protect users by identifying low quality web pages or malicious software or pages, to isolate or improve search results regarding the domain, and/or to improve Internet-based deal flow, such as advertising.

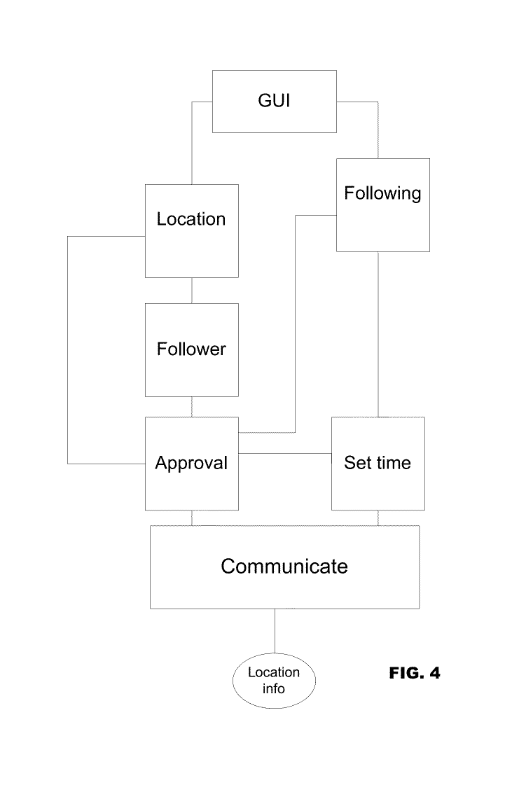

In order to provide this engine, system and method, the present invention may include a variety of servers, as illustrated in FIG. 4. Each of the backend engine and the front end engine may be or include, as discussed hereinabove with respect to FIGS. 1 and 2, at least one microprocessor, such as within a server, and at least one access node to at least one network, such as the Internet.

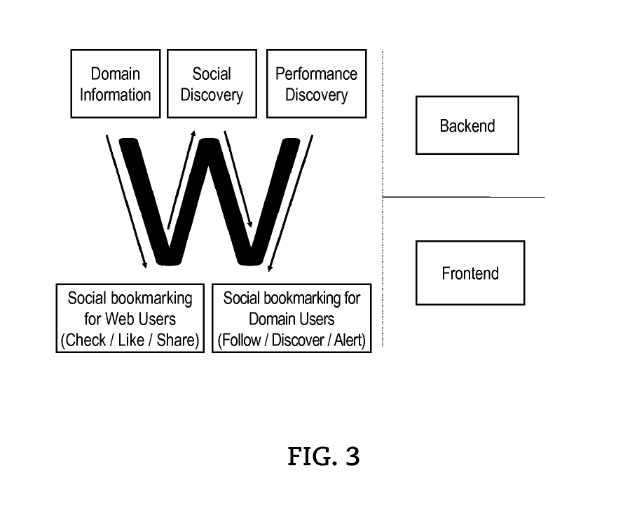

The backend engine, which may take the exemplary format illustrated in FIG. 3, for example, may automatically crawl and collect publicly available domain information, and may use that data to calculate a domain valuation (such as using a formula included in the aspects of the present invention) based on, for example, website traffic, number of followers/favorites markers, searchable page numbers and domain age.

The backend may also, for example, analyze a domain's “adult attribute,” such as based on the domain link outs, keywords and the known adult attributes for certain domains. The backend may further compile domain-competitor data. The accumulated domain information may be generated, for example, as domain report data accessible to users. The access to this domain report data may be exposed, for example, by a browser bookmarklet, a browser add-on, or a domain social network website (hereinafter collectively “bookmarklet”) that may provide a thin-client interface to reporting. Access may further include a vendor feed, such as via an application programming interface (API).

The domain social network bookmarklet may thus be, graphically, a front-end feature that is an add-on to any web browser. As such, it may be downloaded, or dragged and dropped or added via a favorites bar without a software download. In short, the bookmarklet may allow for “social bookmarking,” that is, sharing of bookmarks with others, and indicating to domain owners whether a user has bookmarked the owned domain (such as for marketing/sales purposes).

In an embodiment of the present invention, a user may virtualize a physical or virtual location and identify its type and provide specific control data which may allow at least one other user to become a follower of the location within certain limitations, such as, for example, the time for which the user will follow the particular location. The present invention also may provide single direction tracking and/or group tracking which may be controlled by at least one follower and/or a location owner/creator. Both aspects of the present invention may facilitate at least one social network between users related to a particular location and may further provide a temporal social networking/meeting location for a subset of users.

More specifically, the present invention may allow for small businesses and/or personal users to track and search for users desired to be involved in at least one social experience, such as, for example, a meeting. The tracking provided by the present invention includes the tracking of domain data and the tracking of location data of users. In an embodiment of the present invention, the use of a mobile phone may allow for a mobile application to facilitate mobile tracking of a particular location, whether the location is physical, virtual, mobile and/or stationary.

As illustrated in FIG. 3, a GUI provided with the present invention may provide for a selection and/or creation of at least one location. If a user selects an existing location and would like to follow a particular location, approval may be necessary from an authorized user from that location which may be, for example, the creator of the location(s). If approved, a following user may have access to the location, including access to any communications that may be related to the location. The user being followed, may control which users have access to the particular location and may deny following requests and/or terminate any of a user's privileges at any time.

Any user may have the ability to “hide” from other users, even from authorized users of a location being followed by the “hidden” user, and may have the option to turn off any location identifying information. Of course, the lack of location information may not prohibit participation in location activities and sharing of other information, such as third party user location information and social interactions. Adding a follower may be done via a targeted PIN code, email address, or phone number, for example, and may be effectuated (i.e., registration of a follower may occur) through email, thus allowing access to the system from any internet capable device.

For example, in an embodiment of the present invention, an SMS text may be sent to a potential follower who may click an included URL link or respond with a key word, such as, for example, “accept”, to be added as a follower. An SMS message may include an encrypted URL having associated therewith the phone number of the potential follower embedded in the encryption such that acceptance of the invitation will allow the system to track a particular device. Such functionality may also reduce error rates in the inviting of persons given the direction of the invitation which limits errors, such as, for example, the invited follower entering an erroneous phone number or IP address. If, however, the device held by the invited follower does not contain and/or use a phone number (e.g., an iPad®), a code may be generated by the follower server to allow for the unique association of the device to the present system.

In a similar manner, a unique access identifier may be used with any device and may be shared among devices within a certain proximity to a location. For example, devices “nearby” a created location may receive an invitation to join the location and may each be assigned the same unique identifier. Such common identifier assignment may allow for quick, impromptu meetings and the inclusion of a greater number of participants than may otherwise be possible. Although interaction by registered participants using a common identifier may de facto anonymous, if allowed by the creator of the location, may still occur. Such functionality may allow for quick alerts and the rapid dissemination of information through the location. Flash mobs and other rapidly forming gatherings may also be more easily facilitated through such means.

For example, followers may be added to a location created by a superior, such as a manager, and may have their movements tracked, in real-time by at least the manager. Further, a boss may view where his driver and secretary are from any device having access to the system.

As discussed above, the present invention may allow for secure location and tracking services and may, in particular, allow for the use of temporally limited and virtual location-based information and services. The present invention may utilize at least one location table which may include information related to the location of an object, the location type, associated control and geographical data. As used herein, location type may include information related to such things as a particular mobile device, an IP address of a device, and/or the physical address or virtual address of a particular location. Further, as used herein, control data means information related to the owner or controller of at least one location object and may include, for example, a unique identifier, phone number, email address, IP address, and the like. A unique identifier may be used to avoid duplication of a location object and, as discussed above, to provide a device identifier when one is not otherwise available.

A location object may include, for example, location type information indicating a particular IP address device which may use control data, such as, for example, a phone number, to find the location object and send request to add as follower. A location object whose location type is a mobile device or IP address device, for example, may create a location object whose type is a physical and/or virtual address. Such a device may use a communicatively coupled application to register a location object whose type is, for example, a mobile device, and whose geographical code data will be its GPS geographical position data.

Similarly, a computer device, whether portable or not, may use a conventional browser application to register with, for example, an email account, and establishing its location type, which may be, for example, its IP address. Although such a device may allow for a plurality of email accounts, the one IP address may be associated with each location type used through that particular device. In any case, a type location object may automatically update its geographical data periodically, such as, for example, every 15 seconds. The smaller the time frame allowed for an update may make the collected data more precise and near real-time.

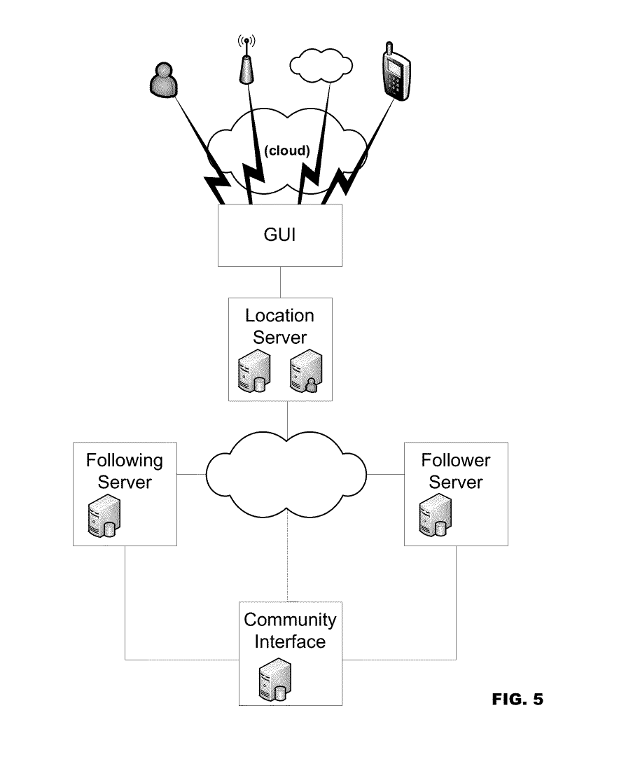

In an embodiment of the present invention, a follower object may be associated with a location object identifier, a follower's location object identifier and a checkout time. As illustrated in FIG. 5, each location object may have a plurality of followers and may be recorded in at least one database in, for example, a follower table. In an embodiment of the present invention, at least two database tables are utilized and may include a location object table and a follower object table, for example.

For example, a mobile device and stationary computer, herein considered two kinds of location object types, may be automatically registered (or added) into at least one location object table via a running mobile application or browser interface with such device having a unique device identification. In an embodiment of the present invention, a mobile device's unique identification may be its device serial number, MAC address or other identification data, such as, for example, an email address login to a browser's web service site such as, for example, through mytracking.com.

Thus, the identified device may create a new location object which may be a physical address type or a virtual address type. A virtual address type may include, for example, a conference call and/or web meeting wherein the participants are not each at the same physical location. As described herein, a follower may be added to a location object and into a follower object table. A follower may then check-in to the location and provide at least one checkout time for its follower object.

Further, a follower may view its following location's geographical data on a map and may thus track a specific user, such as a friend, family member, and/or employee, for example, without exposing the follower's own geographical location through single direction tracking. Similarly, a follower may manually make ‘check in’ so other followers may view the follower's geographical data, on the map, for example, before checkout time expires.

Such a feature may be useful in a group tracking or event tracking setting. For example, a user may wish to track the location of the user's wife and two children. The user may follow each of the three individually and/or have the user and the two children all follow the wife. By way of further example, each of the user, the children and the wife may check-in and may be able to track each other and may be grouped around the wife's number, if, for example the wife does not need to track others and only see her followers. Although, as mentioned above, anyone may checkout and then not be viewed by other followers. Thus, the present invention may allow for one direction tracking, bi-direction tracking and group tracking based on a user following and providing at least one checkout time when appropriate.

By way of non-limiting example, a plurality of phones, such as iPhone 1, iPhone 2, iPhone 3, for example, may be actively running a mobile app communicatively coupled to the present invention, and may auto register at least one new location object (which may be added for the first time to the location table utilizing a unique identifier not otherwise listed in the location object table). Such a location identifier may be objects and may, for example, be denoted as L1, L2 and L3. The addition of such objects may be additive and may allow for followers to be added such that L1 may add L2 as follower, so the follower database may have, for example,

L1, L2, status=1.

If L3 requests to be a follower of L1, for example, the follower database may have, for example,

L1, L3, status=0.

In this way, L1 may be associated with at least one follower, L3, and from a first status=0, may grant to L3 a change status=1, or deny L3 as a follower which may delete such a follower object. Alternatively, if L3 is granted access to be a follower of L1 and L2, the follower table may have, for example,

L1, L2, status=1;

L1, L3, status=1.

Thus, when L2 is a follower of L1, and L2's status=1, for example, L2 may see L1's geographical code (via Location object table L1's geographical data) on at least one visual map and/or by a location description. A location description may include, for example, a street intersection, coordinate(s), map pin and/or other identifier(s) and the like. L2 may also manually “check-in” and may provide a checkout time, such as, for example, 2 hrs, such that the follower table data may be set as:

L1, L2, status=1, checkout=time

L1, L3, status=1.

Similarly, because in this example L3 is a follower of at least L1 (and having a status=1), L3 may have access to L1's geographical data and since L1 is a follower of L2 and the check out time established by L2 is not yet expired, L3 may be availed of L2's geographical data. Thus, the present invention provides, in part, for unique temporally-based tracking features and social network connections.

In an embodiment of the present invention, a mobile device may be used to create a physical location. For example, using a mobile phone in an office environment, the mobile phone's GPS address may be used to create a location called “Office” or a virtual location called “meeting”. Each location may include or have added thereto at least one follower. Each follower associated with the location may view the location on a map, for example, and may view the location of other follower's, whether or not check-in at the location and/or within the range of the map or known location area. Each individual follower may set a checkout time so as to limit the follower's exposure to and of geographical location data. Similarly, the meeting organizer or other authorized individual may set a predefined time limit associated with the location/meeting and/or the follower upon check-in.

As may be appreciated by those skilled in the art in light of the discussion herein, if a location is a mobile location, a follower(s) may track a mobile location and view directions to and/or distance from the real-time position of the location, for example. The adding of followers and the tracking/locating of locations may be assisted by syncing the user's phone number, pin code and/or IP address, for example, with the location server of the present invention. For example, when a mobile phone receives a text message having at least one web link, the web link, once opened will auto register the mobile phone within the system with a unique identifier with or without having access to the phone number of the mobile phone. Once registered, information regarding the user may be shared and sheared by other users. As is illustrated in FIG. 4, the GUI may also allow a user to turn off tracking (using GPS, for example) for all or just a specific follower to provide privacy functionality for each user.

Once a user has been invited to a location, for example, access may be granted to at least one communication access point, such as, for example, a chat room, which may allow for invitees and/or check-in user to a particular location to share information. In addition, the present invention may match a location to a particular place of business, for example, and may provide any associated information related to such business, such as, for example, the business' website link and or other website report data, such as, for example, a domain social network report. For example, if a location is within a hotel, a link to the hotel's domain report may be provided to each invitee and/or checked-in user and may provide information relative to competitive, social discovery data, and the like.

In an embodiment of the present invention, the location-based services may further allow for power savings to be realized by a mobile device. As would be appreciated by those skilled in the art, the use of location-based services, such as, for example, applications utilizing GPS-tracking, consume a great deal of power relative to the actual running of the application on the mobile device, for example. This power consumption is generally caused by the querying of base stations, for example, to continually monitor the location of the mobile device. This not only consumes a great deal of power from the mobile device, but also creates increased traffic within a network.

The present invention may lessen power consumption and reduce network traffic by limiting or reducing the location query when the mobile device is determined to be relatively stationary. For example, if a mobile device becomes stationary for a predetermined period of time, the location query may be reduced until the location of the mobile device changes by at least a predetermined amount. For example, a mobile device which has at least application running which uses location-based information remains within a 50 foot diameter area for over 2 minutes, the query load may be reduced by half. Once the mobile device is detected to have moved greater than the predetermined distance, the query load may be returned to normal.

Further, user information, such as meeting schedules and prior use of applications utilizing location-based services may also be used to increase power savings by limiting and/or discontinuing location queries by a mobile device. For example, a user may have a one hour meeting calendared for a specific location and may use a navigation assistance program to locate the meeting location. However, once reaching the meeting, the user of the device may not manually discontinue the navigation assistance program in anticipation of using the program after the meeting has concluded. The present invention, may utilize this information and may determine that given the user has reached the location of the meeting, the location queries may be limited and/or discontinued until the meeting is concluded.

Similarly, a user's prior location information may also allow for power savings by limiting and/or discontinuing location queries. For example, the present invention may track and/or record the location of the device throughout a predetermined time period, such as over a week, for example. Such information may allow the present invention to determine that the device is generally stationary during long periods of the week (like an average workday, for example).

By way of non-limiting example only, a user may general spend from about 9 am to about 12 pm in a particular location, such as a building. Although the user may walk about the office space and/or may leave the building proper for a small break, to smoke, for example, the user may generally be within the confines of the building during each work day. Once a pattern is established, the present invention may temporally fix the users location for the period so defined. If the user leaves the building grounds at 10 am, for example, and the location query has been deactivated (versus being reduced), a user may have the option to manually reengage the location query functionality. Although some types of employment, such as nursing, often require varying schedules of work, the present invention may disable or reduce location queries based on the frequency and/or time spent in a particular location by the user/device.

Those of skill in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A method for providing power savings in a location-based social network, comprising:
providing at least one non-transitory computer readable storage medium having encoded thereon computer executable instructions for operating at least one a location object resident on at least one server;
requesting that at least one mobile device communicatively coupled to the at least one server access the at least one location object, wherein the at least server temporarily tracks the location of the at least one mobile device; and
calculating at least one period of sleep time correspondent to at least one location of the at least one mobile device, wherein the at least one mobile device is resident in the at least one location for a predetermined period of time;
wherein the questing of the at least one mobile device to access the at least one location object is reduced during said sleep time.

2. The system of claim 1, wherein the predetermined period of time is greater than one hour.

3. The system of claim 1, wherein the sleep time is less than the predetermined time.
